(19) United States
(12) Patent Application Publication
(10) Pub. No.: US 2012/0139944 A1
(43) Pub. Date: Jun. 7, 2012

(54) INFORMATION PROCESSING APPARATUS, INFORMATION PROCESSING SYSTEM, AND INFORMATION PROCESSING METHOD

(75) Inventors: Shinobu Kuriya, Kanagawa (JP); Masatoshi Ueno, Kanagawa (JP); Kenichi Kabasawa, Saitama (JP); Hideo Kawabe, Saitama (JP); Tetsuro Goto, Tokyo (JP); Tsubasa Tsukahara, Tokyo (JP); Toshiyuki Nakagawa, Kanagawa (JP)

(73) Assignee: Sony Corporation, Tokyo (JP)

(21) Appl. No.: 13/305,933

(22) Filed: Nov. 29, 2011

(30) Foreign Application Priority Data
Dec. 6, 2010 (JP) 2010-271279

(51) Int. Cl. G09G 5/00

(52) U.S. Cl. 345/649

(57) ABSTRACT

An information processing apparatus includes: a generation unit generating object information including at least information for displaying an object to rotate at a velocity corresponding to a rotation velocity, which is detected by a rotation sensor installed in an operation device operated by a user, within a screen based on the rotation velocity; and a changing unit changing the object information generated by the generation unit based on a pressure detected by a pressure sensor installed in the operation device.

### BACKGROUND

The present disclosure relates to an information processing apparatus, an information processing system, and an information processing method capable of performing a process based on information detected by a pressure sensor or the like.

An information processing system disclosed in Phamplet of International Publication No. 2008-111138 includes a disk-shaped operation device and a display device. The operation device includes an acceleration sensor, a gyro sensor, or a pressure sensor. The operation device is operated by a user, the display device receives an operation signal transmitted from the operation device, and a motion of an object such as a cursor on a screen is displayed in accordance with the received operation signal. In particular, the information processing system has characteristics in which the processing contents of an operation are changed in accordance with both a method of holding the operation device by the user and a method of operating the operation device. For example, the information processing system changes an advancing or retreating speed of the object on the screen in accordance with a pressure value detected by the pressure sensor (for example, see paragraphs [0046] and [0054] of Pamphlet of International Publication No. 2008-111138).

In an image display apparatus disclosed in Japanese Unexamined Patent Application Publication No. 2009-087026, a user operates a three-dimensional character or the like on the screen by inputting a gesture using a spherical gesture input remote controller including an acceleration sensor, an angular velocity sensor, and a pressure sensor (for example, see paragraphs [0085] and [0086] and FIGS. 13 and 14 of Japanese Unexamined Patent Application Publication No. 2009-087026).

### SUMMARY

Operation devices including a motion sensor such as an acceleration sensor or a gyro sensor have come into widespread use. In particular, operation devices including a pressure sensor have started to be used as human interfaces. Accordingly, in future, it is considered that information processing techniques using the human interfaces are necessarily embodied, regardless to the field.

It is desirable to provide an information processing apparatus, an information processing system, and an information processing method capable of realizing motions operated intuitively by users and special motions of an object on a screen by the use of an operation device including at least a pressure sensor.

According to an embodiment of the disclosure, there is provided an information processing apparatus including a generation unit and a changing unit.

The generation unit generates object information including at least information for displaying an object to rotate at a velocity corresponding to a rotation velocity, which is detected by a rotation sensor installed in an operation device operated by a user, within a screen based on the rotation velocity.

The changing unit changes the object information generated by the generation unit based on a pressure detected by a pressure sensor installed in the operation device.

According to the embodiment of the disclosure, since the object information regarding the rotation velocity is changed by the changing unit based on the pressure detected by the operation device, a change in the rotation state of the object can be displayed in the screen in accordance with the pressure. Thus, the user can execute an intuitive operation using the pressure when the user grasps the operation device.

The changing unit may change the object information so as to make the rotation velocity of the object small when the detected pressure becomes large.

The information processing apparatus may further include a retention unit retaining a maximum value of the rotation velocity detected within a predetermined period after the rotation sensor detects the rotation velocity. In this case, the generation unit may generate the object information so as to maintain rotation of the object at a rotation velocity corresponding to the retained maximum value. By retaining the maximum value of the rotation velocity, the motion of the accelerated rotation of the operation device within the predetermined period can be reflected as the motion of the smoothly accelerated rotation of the object.

The changing unit may change the object information so as to start rotation of the object when the detected pressure is equal to or greater than a threshold value, whereas changing the object information so as to stop the rotation of the object when the detected pressure is less than the threshold value.

The information processing apparatus may further include a unit calculating a rotation direction of the operation device. The generation unit may generate the object information so as to rotate the object in a direction corresponding to the calculated rotation direction. The rotation direction of the operation device can be detected by a calculation method using a biaxial or triaxial rotation sensor or an acceleration sensor and the rotation sensor in combination.

The generation unit may generate the object information including information in accordance with a movement velocity, which is obtained based on an acceleration detected by an acceleration sensor installed in the operation device, so that the object is moved at a velocity corresponding to the movement velocity on the screen based on the movement velocity. In this case, the changing unit may change the object information generated by the generation unit so that the movement velocity of the displayed object is changed based on the pressure detected by the pressure sensor. Accordingly, since the object information regarding the movement velocity is changed based on the pressure input and detected in the operation device by the changing unit, the change in the movement state of the object can be displayed within the screen in accordance with the pressure.

The changing unit may change the object information so that the movement of the object stops when the detected pressure is less than a threshold value.

The information processing apparatus may further include a unit calculating a movement direction which is a direction of the operation device at a movement velocity. In this case, the generation unit may generate the object information so that the object is moved in the calculated movement direction.

The changing unit may change the object information so that the movement direction of the object is changed in accordance with the detected rotation velocity. Accordingly, the intuitive display of the object can be realized such that the movement direction is variable in accordance with the rotation velocity of the operation device.

The changing unit may change the object information so that a size, a movement distance, or a color of the object is changed in accordance with the detected pressure.

The operation device may include a base body which has any shape, three or more pressure sensors which are set at each of a plurality of regions partitioned from at least a part region of a surface of the base body and are installed at different vertex positions of a polygon having three or more angles, and a plurality of plates which is disposed so as to cover the surface of the base body with the three or more pressure sensors interposed therebetween to correspond to each region of the base body.

Three or more depressurization sensors installed at the different vertex positions of a polygon having three or more angles in each region can detect contact of a contacting object such as a finger of the user on the plate corresponding to the region. Accordingly, the operation device having the surface of the base body with any shape as a detection surface can be realized with a relatively small number of sensors.

According to an embodiment of the disclosure, there is provided an information processing system including an operation device and a display control apparatus.

The operation device includes a rotation sensor, a pressure sensor, and a transmission unit transmitting information regarding a rotation velocity detected by the rotation sensor and information regarding a pressure detected by the pressure sensor. The operation device is operated by a user.

The display control apparatus includes a reception unit which receives the information regarding the rotation velocity and the information regarding the pressure, a generation unit generating object information including at least information for displaying an object to rotate at a velocity corresponding to the received rotation velocity within a screen, and a changing unit changing the object information generated by the generation unit based on the received information regarding the pressure.

According to still another embodiment of the disclosure, there is provided an information processing method which includes generating object information including at least information for displaying an object to rotate at a velocity corresponding to a rotation velocity, which is detected by a rotation sensor installed in an operation device operated by a user, within a screen based on the rotation velocity.

The generated object information is changed based on a pressure detected by a pressure sensor installed in the operation device.

According to still another embodiment of the disclosure, there is provided an information processing apparatus including a generation unit and a changing unit.

The generation unit generates object information including information for displaying an object to move at a velocity corresponding to a movement velocity, which is obtained based on an acceleration detected by an acceleration sensor installed in an operation device operated by a user, within a screen based on the movement velocity.

The changing unit changes the object information generated by the generation unit so as to change a direction of the movement velocity based on a rotation velocity detected by a rotation sensor installed in the operation device.

In the related art, there is no function of displaying an object in accordance with the rotation of the operation device with high intuition. According to the embodiment of the disclosure, however, the intuitive display of the object can be realized such that the movement direction is variable in accordance with the rotation velocity of the operation device.

According to still another embodiment of the disclosure, there is provided an information processing apparatus including an acquisition unit and a user operation detection unit.

The acquisition unit acquires pressure information from a pressure sensor installed in an operation device operated by a user.

The user operation detection unit determines start and end of an operation by a toggle process so as to determine, the start of the operation, and the operation of the user when a pressure equal to or greater than a threshold value is acquired within a predetermined period from a time of acquiring a pressure less than the threshold value and the pressure less than the threshold value is again acquired.

Accordingly, switching the start and the end of the operation using the operation device can be realized in response to the pressure operation on the operation device by the user.

According to further still another embodiment of the disclosure, there is provided an information processing apparatus including an acquisition unit and a user operation detection unit.

The acquisition unit acquires pressure information from a pressure sensor installed in an operation device operated by a user.

The user operation detection unit starts reception of the operation of the user from a time when the pressure sensor acquires a pressure equal to or greater than a threshold value and which ends the reception of the operation of the user when a pressure less than the threshold value is detected.

Accordingly, switching the start and the end of the operation using the operation device can be realized in response to the pressure operation on the operation device due to the user.

According to the embodiments of the disclosure, the user can realize a special motion of the object within the screen with high intuition using the operation device including at least the pressure sensor.

### BRIEF DESCRIPTION OF THE DRAWINGS

FIG. 1 is a diagram of an information processing system according to an embodiment of the disclosure;

FIG. 2 is a diagram of the hardware configuration of an operation device;

FIG. 3 is a diagram of the software configuration of the operation device;

FIG. 4 is a diagram of the hardware configuration of a display device;

FIG. 5 is a diagram of the software configuration of the display device;

FIG. 6 is a diagram of a sequence of a basic operation of the information processing system with the configuration;

FIG. 7 is a flowchart of a process of the user operation detection function according to an embodiment;

FIG. 8 is a flowchart of an operation of the user operation detection function according to another embodiment;

FIG. 9 is a flowchart of a process when the user rotates an object using the operation device according to an embodiment and a process performed by the object information management function;

FIG. 10 is a flowchart of a process when a pressure on the operation device due to the user is proportional to a rotation velocity;

FIG. 11 is a flowchart of a process in a case where a movement velocity of the object is varied in accordance with a pressure operated in the operation device by the user;

FIG. 12 is a flowchart of a process in a case where the pressure and a movement velocity on the operation device of the user are proportional to each other;

FIG. 13 is a diagram of the outer appearance and a use form of the operation device;

FIG. 14 is a sectional view of the configuration of the operation device in FIG. 13;

FIG. 15 is a diagram of a base body surface of the operation device in FIG. 14 indicated in the direction of an arrow X;

FIGS. 16A and 16B are a plan view and a side view of a detection principle;

FIG. 17 is a diagram of the detection principle when a pressure-sensitive sensor is used to correspond to positive and negative pressures;

FIG. 18 is a diagram of a method of calculating a pressurization position;

FIG. 19 is a diagram of a method of calculating the pressurization position when the base body has a three- dimensional shape such as a spherical shape; and

FIG. 20 is a diagram of a method of operating the operation device.

### DETAILED DESCRIPTION OF EMBODIMENTS

Hereinafter, an embodiment of the disclosure will be described with reference to the drawings.

### Configuration of Information Processing System

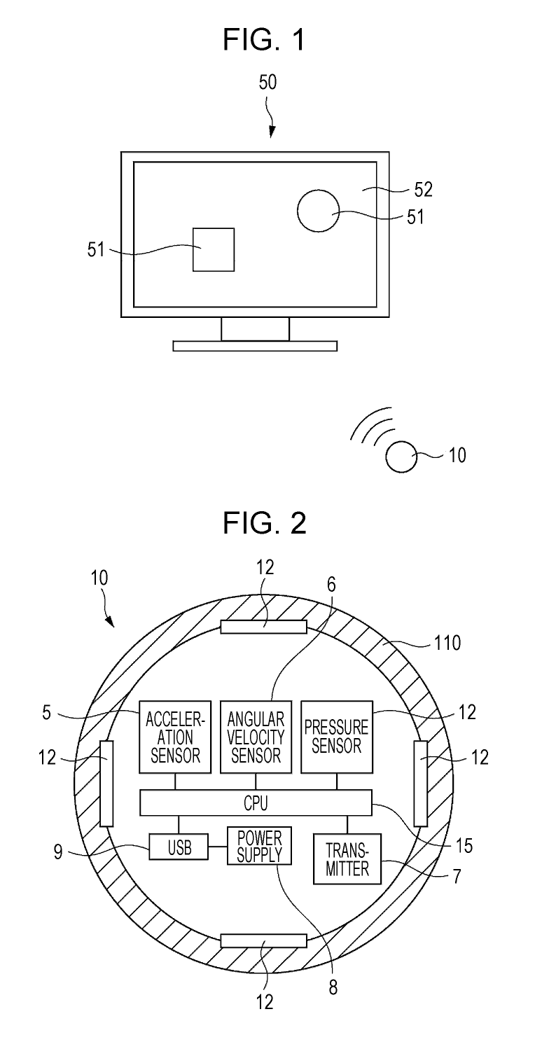

FIG. 1 is a diagram of an information processing system according to an embodiment of the disclosure.

The information processing system includes an operation device 10 operated by a user and a display device 50 receiving operation information transmitted from the operation device 10 and performing a display process based on the operation information.

The operation device 10 has a size for being grasped by a user with his or her hands and, for example, a spherical shape. The display device 50 functions as a display control device which controls a display such that an object 51 is rotated or moved within a screen of a display unit 52 by an operation of the user using the operation device 10.

FIG. 2 is a diagram illustrating the hardware configuration of the operation device 10. The operation device 10 includes an acceleration sensor 5, an angular velocity sensor 6 serving as a rotation sensor, pressure sensors 12, a CPU 15, a transmitter 7, and a power supply 8. A USB interface 9 is also installed in the operation device 10.

These sensors and the CPU 15 are disposed inside the spherical casing 110 so as to be fixed to the casing 110. The plurality of pressure sensors 12 is mounted on the inner surface of the casing 110 and the pressure sensor group detects the pressurization position of the user and the pressure. A sensor expressing pressure, for example, by a variation in an electric resistance is used as the pressure sensor 12. Examples of the configuration of the spherical operation device 10, the pressurization position, and a pressure calculation method will be described below with reference to FIG. 13 and the subsequent drawings.

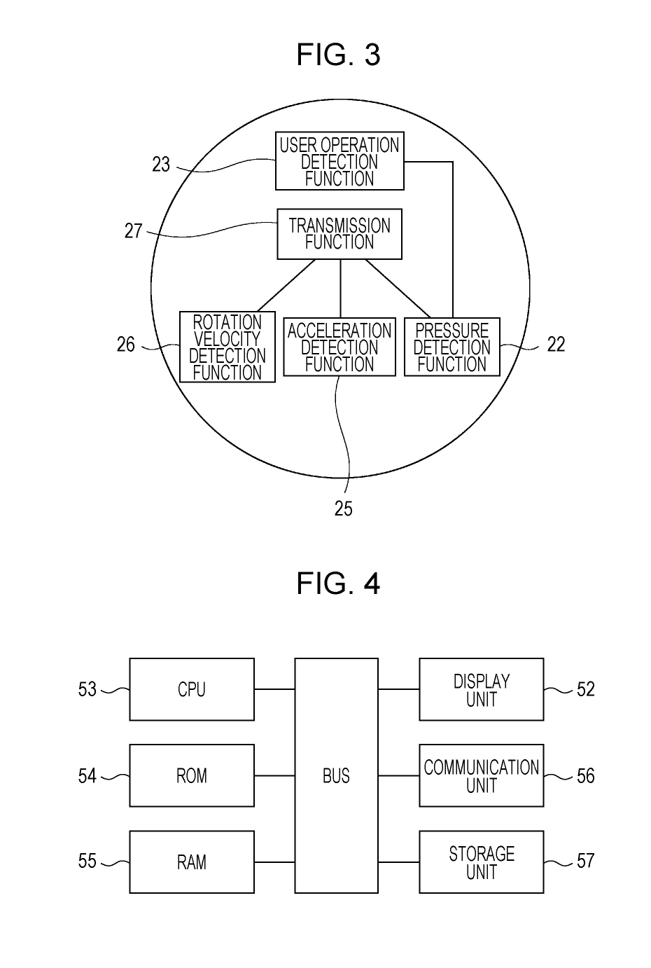

FIG. 3 is a diagram of the software configuration of the operation device 10. The operation device 10 includes an acceleration detection function 25, a rotation velocity detection function 26, a pressure detection function 22, a user operation detection function 23, and a transmission function 27.

The acceleration detection function 25 detects an acceleration applied to the operation device 10 based on a signal output from the acceleration sensor 5. The rotation velocity detection function 26 detects a rotation velocity of the operation device 10 based on the signal output from the angular velocity sensor 6. The pressure detection function 22 detects a pressured applied to the operation device 10 based on the signal output from the pressure sensor 12. The user operation detection function 23 detects whether the user grasps and operates the operation device 10 based on information obtained from at least one of these sensors. The transmission function 27 transmits information obtained from the respective function by the use of the transmitter 7 using radio communication such as infrared light.

The operation device 10 includes, for example, an acceleration sensor having orthogonal triaxial detection axes and an angular sensor having orthogonal triaxial detection axes, so as to calculate the acceleration and the rotation velocity of the object 51 corresponding to the motion of the operation device 10 in all directions in a three-dimensional space. The acceleration and the rotation velocity are generally calculated by an object information management function 63 of the display device 50 described below.

Alternatively, in some cases, the operation device 10 may not have a spherical shape shown in FIG. 1 and the like but may have a shape by which a method of grasping the operation device by the user is actually determined. In this case, the operation device may include, for example, an acceleration sensor having orthogonal biaxial detection axes and an angular sensor having orthogonal biaxial detection axes, so as to calculate the acceleration and the rotation velocity of the object 51 corresponding to the motion of the operation device in all directions in a three-dimensional space.

FIG. 4 is a diagram of the hardware configuration of the display device 50. The display device 50 includes a CPU 53, a ROM 54, a RAM 55, a display unit 52, a communication unit 56, and a storage unit 57 like a general computer. These units are connected to each other by a bus. Here, the communication unit 56 mainly functions as a receiver. The storage unit 57 is generally an auxiliary (secondary) storage unit of the ROM 54 or the RAM 55.

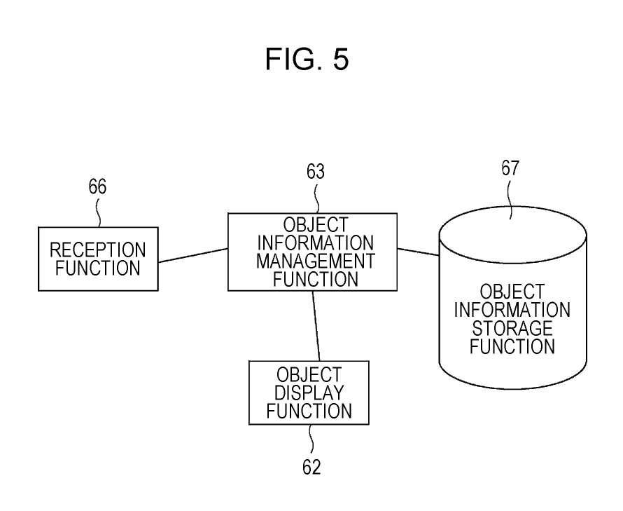

FIG. 5 is a diagram of the software configuration of the display device 50. As shown in FIG. 5, the display device 50 includes a reception function 66, an object information management function 63, an object display function 62, and an object information storage function 67.

The reception function 66 receives the information transmitted from the operation device 10 by the communication unit 56. The object information management function 63 manages object information. The object information is information for displaying the object 51 on a screen. For example, the object information is information regarding the position, direction, color, three-dimension, or the like of the object 51. The object display function 62 displays the object 51 on the display unit 52 based on the object information. The object display function 62 realizes the movement and rotation of the object 51 in various directions on the screen based on the information regarding the position, direction, and color, three-dimension, or the like of the object 51, and thus can realize a variation in the form (form, size, color, or the like) of the object 51. The object information storage function 67 stores the object information in the RAM 55 or the storage unit 57.

The display device 50 has a configuration in which a control portion receiving the information transmitted from the operation device 10 and controlling the display of the object 51 is integrated with the display unit 52, but the control portion and the display unit 52 may be separately connected to each other so as to communicate with each other in wired way or wireless way.

### Basic Operation of Information Processing System

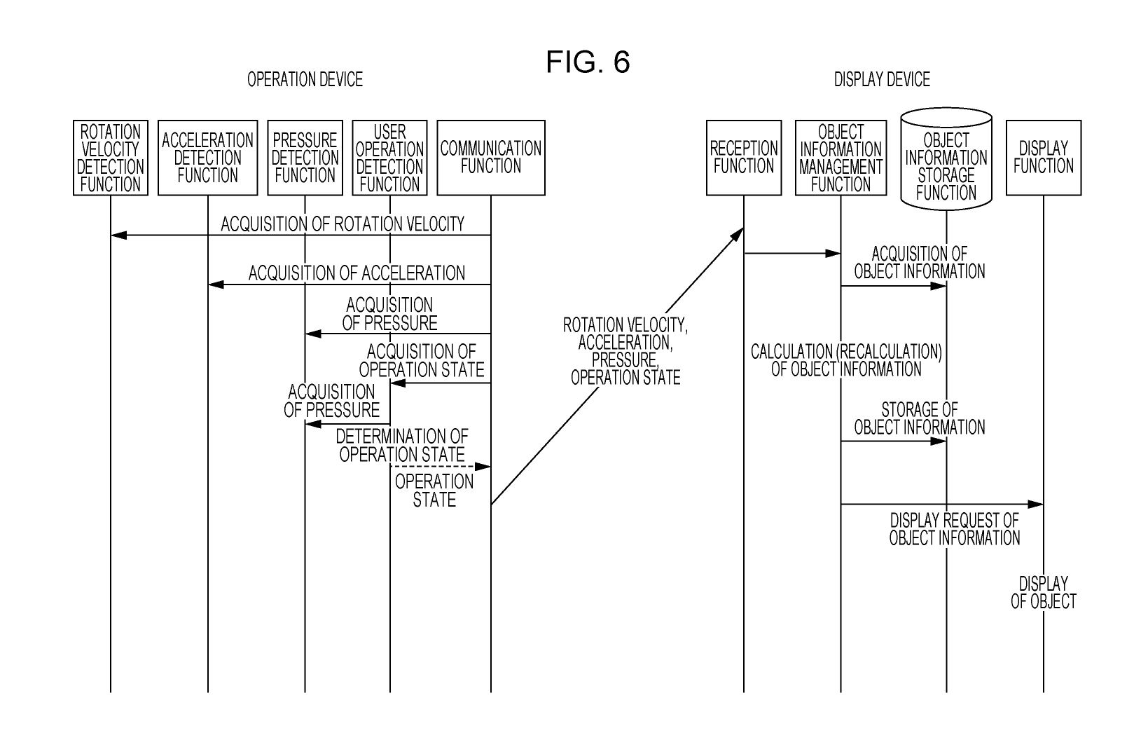

FIG. 6 is a diagram of a sequence of a basic operation of the information processing system with the above-described configuration. The left side of FIG. 6 is a sequence of the operation device 10 and the right side of FIG. 6 is a sequence of the display device 50.

For example, the user operation detection function 23 of the operation device 10 acquires the pressure output from the pressure sensor 12 and determines an operation state (during operation or during non-operation) of the user based on information regarding the pressure. The user operation detection function 23 transmits information regarding the operation state of the user to the transmission function 27 in response to a request from the transmission function 27. When user operation detection function 23 detects that the operation state of the user is during the operation, the transmission function 27 periodically acquires the operation information, that is, respective information regarding the rotation velocity, the acceleration, and the pressure detected by the rotation velocity detection function 26, the acceleration detection function 25, and the pressure detection function 22, and then transmits the respective information to the display device 50.

In the display device 50, the reception function 66 receives such information. The object information management function 63 acquires the received information, generates the object information by calculation based on the information, and stores the object information in the object information storage function 67. When the reception function 66 receives the information after the second information, the object information management function 63 performs the following process. That is, the object information management function 63 reads the previous object information from the object information in the object information storage function 67 and changes (updates) the read object information. The object information management function 63, the CPU, and the like performing such a process function as an object information generation unit and an object information changing unit.

The object information management function 63 makes a display request to the object display function 62 based on the stored object information. The object display function 62 displays the object 51 on the display unit 52 based on the object information.

### Example of Operation of Information Processing System

### Example 1

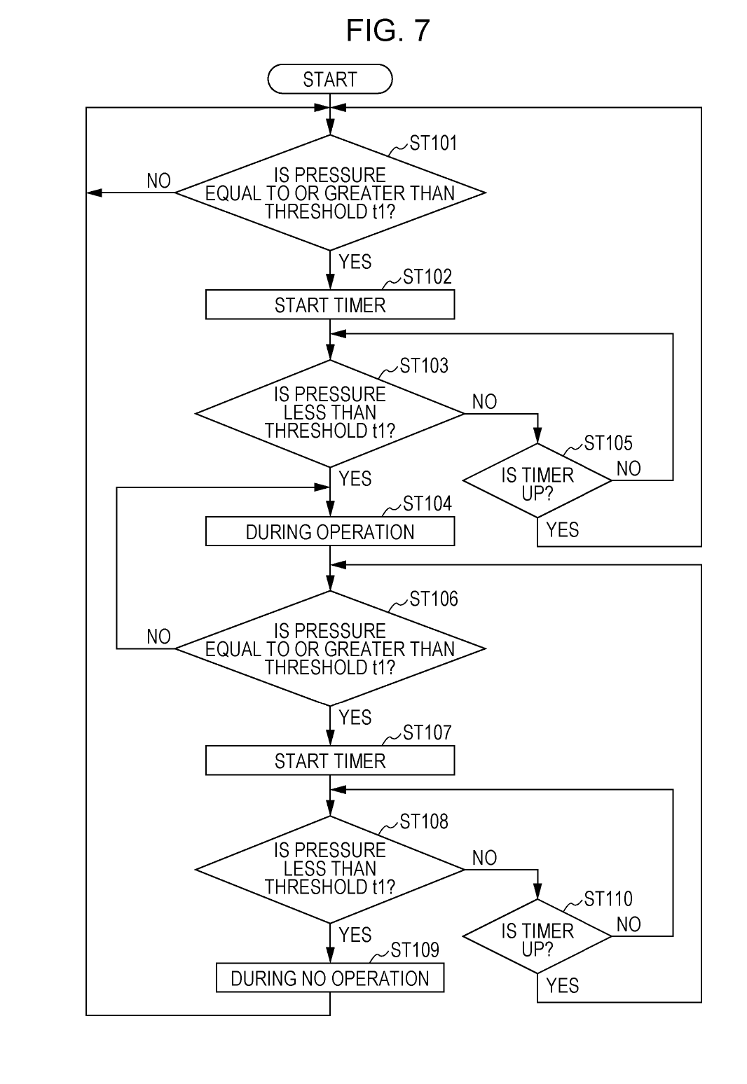

FIG. 7 is a flowchart of the process of the user operation detection function 23 according to an embodiment. In the process, for example, the information regarding the pressure is used. That is, it is determined whether the user grasps the operation device 10 based on the detection of the pressure detection function 22. That is, it is determined whether the user operates the operation device 10. In the process, the user operation detection function 23, the CPU 15, and the like function as a user operation detection unit.

As shown in the drawing, the user operation detection function 23 determines whether the detected pressure is equal to or greater than a threshold value (step 101). When the detected pressure is equal to or greater than a threshold value t1, a timer starts (step 102). When the detected pressure is less than the threshold value t1 after the start of the timer (YES in step 103), it is determined that the user is operating the operation device 10 (step 104). The determination process of step 103 is performed until the timer is UP (step 105).

The processes of step 101 to 105 are the same as a clock operation used in a pointing device.

When the pressure equal to or greater than the threshold value t1 is detected during the operation of the operation device 10 of the user (step 106), the timer starts (step 107). When the pressure detected after the start of the timer is less than the threshold value t1 (YES in step 108), the non-operation is determined (step 109). The determination process of step 108 is performed until the timer is UP (step 110).

Generally, the threshold values t1 in each step are all the same value, but a difference may occur in at least one threshold value t1.

The user operation detection function 23 detects the pressure of the value equal to or greater than the threshold value t1 within a predetermined period from a time point, at which the pressure less than the threshold value t1 is acquired, and determines that the operation of the user starts when the pressure less than the threshold value t1 is detected again (step 104). Thereafter, the user operation detection function 23 alternately determines a toggle process, that is, the start and end of the operation of the user, like ON/OFF operations of a switch. Accordingly, the start and the end of the operation performed using the operation device 10 are switched in response to the pressure operation on the operation device 10 due to the user.

### Example 2

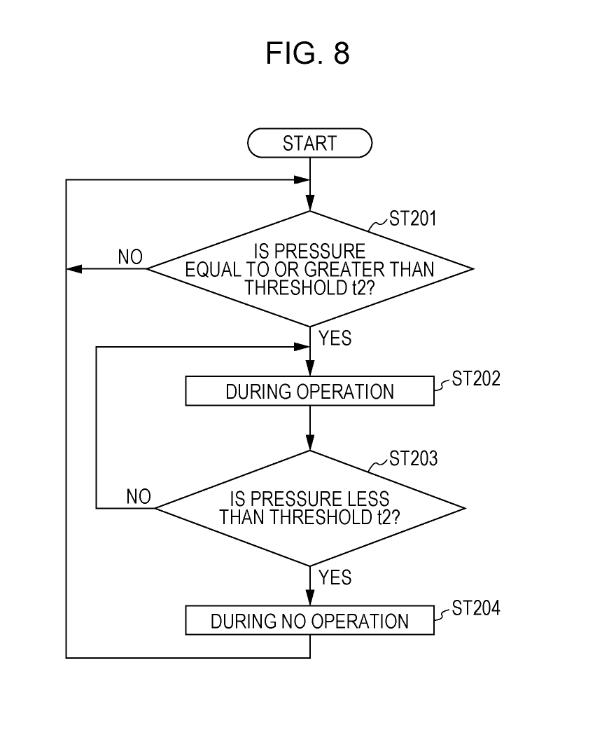

FIG. 8 is a flowchart of an operation of the user operation detection function 23 according to another embodiment. In the process, the user operation detection function 23, the CPU 15, and the like function as a user operation detection unit.

In this embodiment, the user operation detection unit starts receiving the operation of the user from a time point, at which the pressure equal to or greater than a threshold value t2 is detected (step 201 and step 202) and ends the reception of the operation of the user from a time point at which the pressure less than the threshold value t2 is detected (step 203 and step 204). By this process, the start and the end of the operation performed using the operation device 10 are switched in response to the pressure operation on the operation device 10 due to the user. The threshold value t2 may be the same value as or different from the threshold value t1 in FIG. 7.

### Example 3

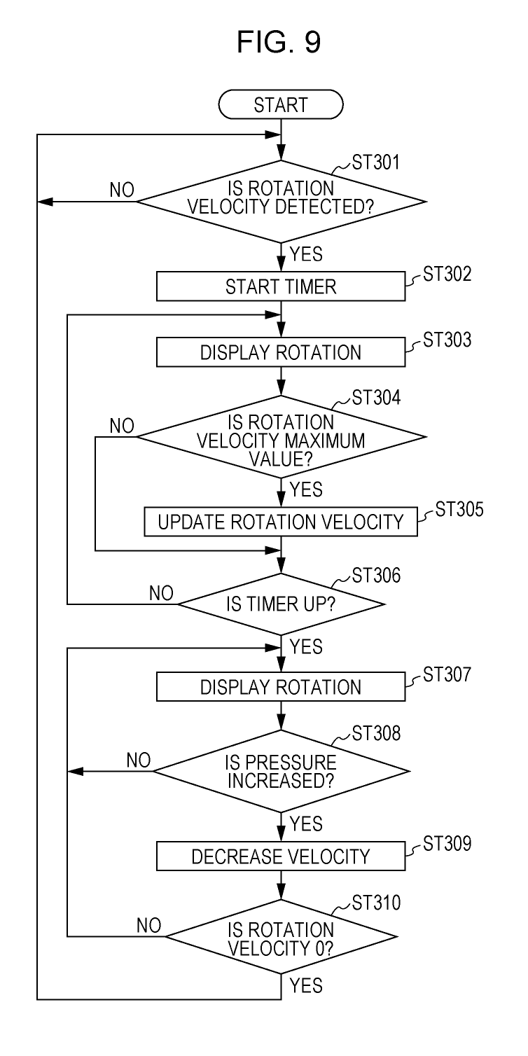

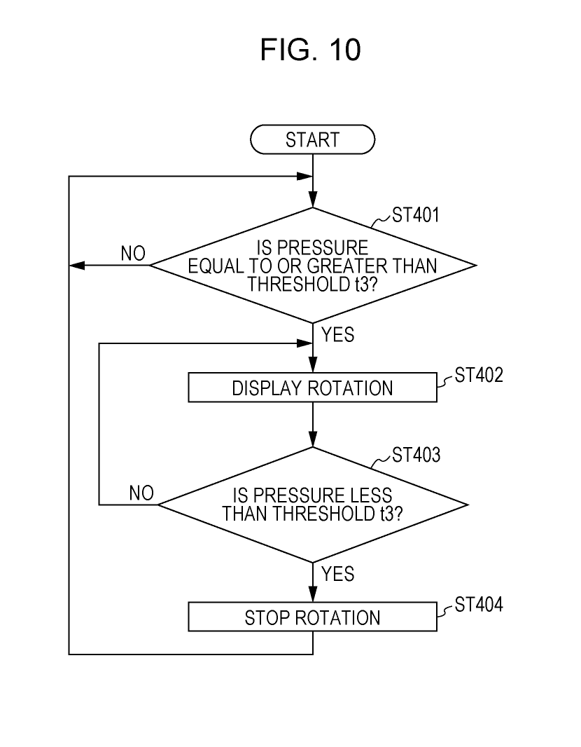

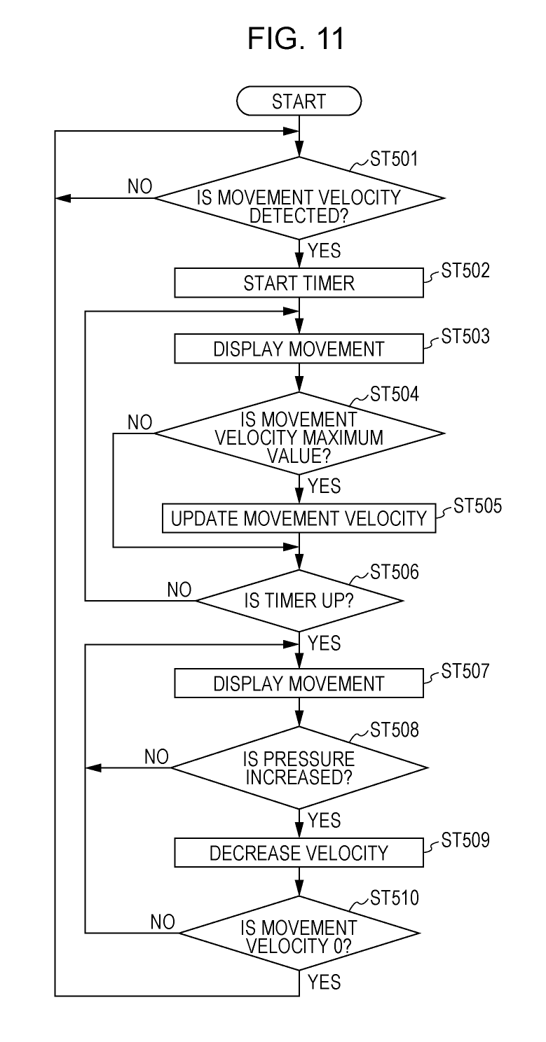

FIG. 9 is a flowchart of a process when the user rotates the object 51 using the operation device 10 according to an embodiment and a process performed by the object information management function 63. Here, it is assumed that the user is operating the operation device 10 using the user operation detection function 23. The same is applied to FIGS. 10 and 11.

The object information management function 63 starts the timer (step 302) to detect the rotation velocity (angular velocity) of the operation device 10 (YES in step 301).

After the start of the timer, the object information management function 63 updates the maximum value of the rotation velocity until the timer is UP (step 304 to step 306). That is, the maximum value of the rotation velocity is updated while the maximum value of the rotation velocity is retained. A period from the start of the timer to UP is, for example, 1 second or less.

After the predetermined period from the start of the timer to UP is elapsed, the object information management function 63 generates the object information so as to rotate the object 51 at the rotation velocity in accordance with the retained maximum value and displays the object information on the object display function 62 (step 303 and step 307). In this case, as described above, since the operation device can detect the acceleration and the rotation velocity in all the directions in the three-dimensional space, the object 51 is displayed, for example, so as to be rotated in substantially the same direction as the rotation direction of the operation device due to the user on the screen.

By retaining the maximum value of the rotation velocity, the motion of the accelerated rotation of the operation device 10 during a predetermined period can be reflected as a motion of smoothly accelerated rotation of the object 51 even when camera shaking or the like due to the user occurs.

When the object 51 rotated at the rotation velocity in accordance with the maximum value is displayed, the object information management function 63 changes the object information based on the information regarding the pressure obtained by the pressure detection function 22 so as to change the rotation velocity of the object 51. For example, when the pressure increases (YES in step 308), the object information is changed so as to decrease the rotation velocity (step 309). For example, when the pressure equal to or greater than a threshold value is detected, the deceleration may start. When the detected pressure is constant, the deceleration may be constant. That is, the larger the detected pressure is, the smaller the rotation velocity is.

When the pressure is applied until the rotation velocity becomes zero, the object information management function 63 returns the process to step 301 (step 310).

Examples of the object 51 in Example 3 include a tire of an automobile, a ball thrown by a pitcher in baseball, a map, and a globe. When the object 51 is a tire of an automobile, the detected pressure corresponds to a brake force for decelerating the travelling speed of the automobile.

Since the object information regarding the rotation velocity is changed based on the pressure detected by the operation device 10, a variation in the rotation state of the object 51 in accordance with the pressure can be displayed on the screen. Accordingly, an intuition operation can be performed using the pressure at which the user grasps the operation device.

### Example 4

FIG. 10 is a flowchart of a process when the pressure and the rotation velocity on the operation device 10 due to the user are proportional to each other. That is, when the detected pressure is equal to or greater than a threshold value t3, the object information management function 63 displays the object 51 so as to be rotated in accordance with the pressure (step 401 and step 402). When the detected pressure is less than the threshold value t3, the object 51 is displayed so that the rotation of the object 51 stops (step 403 and step 404).

When the object 51 in Example 4 is, for example, a tire of the automobile, the pressure becomes an accelerator for accelerating the travelling speed of the automobile.

### Example 5

FIG. 11 is a flowchart of a process in a case in which the movement velocity of the object 51 is varied in accordance with the pressure operated with the operation device 10 of the user. Here, the movement means translation movement including no rotation. In the process in the flowchart, the “rotation velocity” in FIG. 9 is substituted by the “movement velocity.” The movement velocity is calculated by integrating the acceleration detected by the acceleration detection function 25.

Accordingly, since the object information regarding the movement velocity is changed based on the pressure input and detected in the operation device 10, a variation in the movement state of the object 51 in accordance with the pressure can be displayed on the screen. In this case, as described above, since the operation device can detect the acceleration and the rotation velocity in all the directions in the three-dimensional space, the object 51 is displayed, for example, so as to be moved in substantially the same direction as the translation movement direction of the operation device due to the user on the screen.

By retaining the maximum value of the rotation velocity, the accelerated motion of the operation device 10 during a predetermined period can be reflected as a motion of smoothly accelerated movement of the object 51 even when camera shaking or the like due to the user occurs.

### Example 6

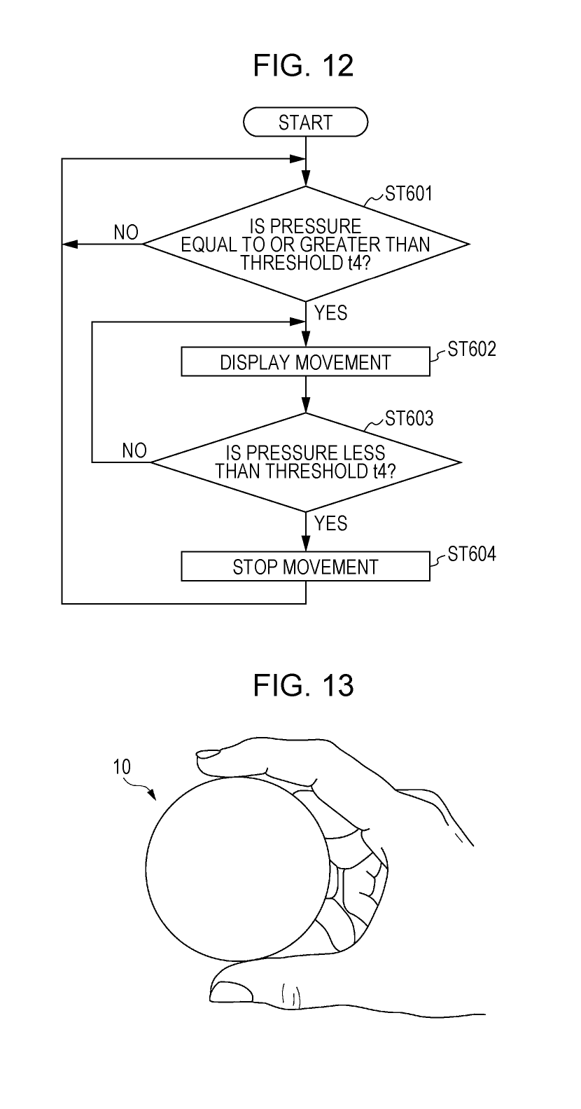

FIG. 12 is a flowchart of a process in a case where the pressure and the movement velocity on the operation device 10 due to the user are proportional to each other. In the process in the flowchart, the “rotation” in FIG. 10 is substituted by the “movement.” The movement velocity is calculated by integrating the acceleration, as described above.

### Example 7

The movement direction (direction of the movement velocity) of the object 51 may be changed in accordance with the rotation velocity of step 401 shown in FIG. 10 or the like. In this case, both the rotation velocity and the movement direction of the object 51 are displayed so as to be changed in accordance with the pressure operated in the operation device 10 by the user. For example, when the object 51 is a ball drawn by a pitcher, the higher the rotation velocity of the ball is, the larger the curved degree, that is, the degree of change of the movement direction per unit time is. When the detected pressure is constant, the degree of change of the movement direction becomes constant. When the pressure gradually increases, the movement direction is gradually changed.

In a case of Example 7, for example, the movement direction may be associated in accordance with the rotation direction. That is, the initial movement direction can be determined in advance in accordance with the rotation direction at the rotation start time. Therefore, the movement direction may be changed in accordance with the rotation velocity (pressure).

As another example, the movement velocity and the direction of the object 51 may be changed in accordance with the detected rotation velocity irrespective of the detected pressure. Thus, the object 51 of which the movement direction is variable can be displayed intuitively in accordance with the rotation velocity of the operation device 10.

As still another example, the size, the movement distance, or the color of the object 51 may be changed in accordance with the detected pressure. The change in the movement distance in accordance with the pressure means, for example, the change in the position in a depth direction based on stereoscopic information of the object 51. In this case, the larger the detected pressure is, the larger the inward travelling distance of the object 51 is. That is, the inward travelling speed is displayed so as to be increased.

### Spherical Operation Device

Hereinafter, a spherical operation device will be described according to a specific embodiment.

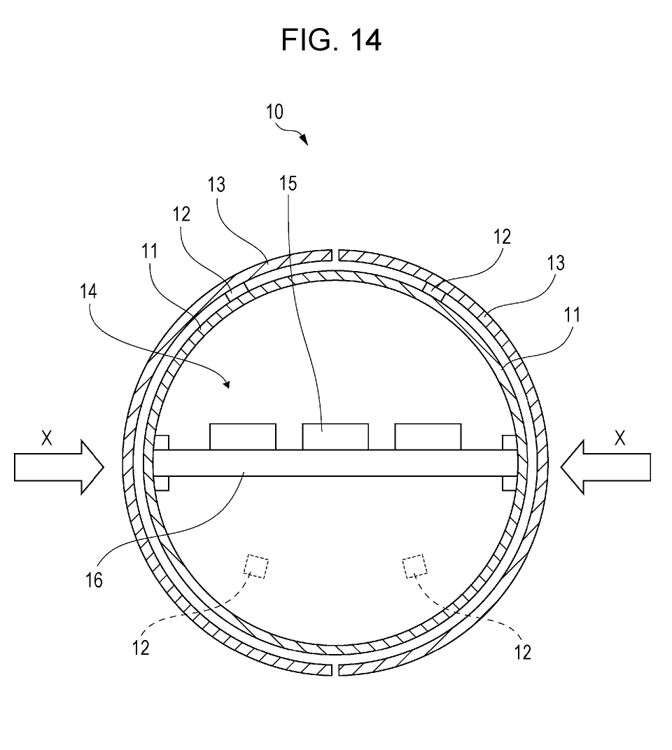

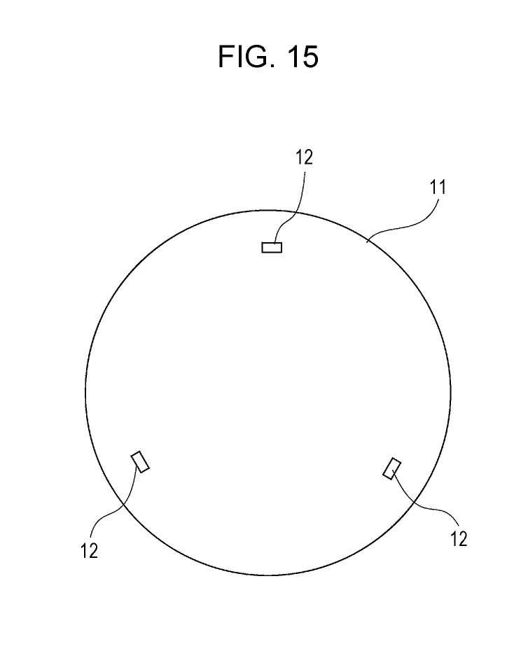

FIG. 13 is a diagram of the outer appearance and a use form of the operation device 10. FIG. 14 is a sectional view of the configuration of the operation device 10 in FIG. 13. FIG. 15 is a diagram of a base body surface of the operation device 10 in FIG. 14 indicated in a direction of an arrow X.

As shown in the drawings, the operation device 10 includes a base body 11 with any stereoscopic shape, three or more depressurization sensors (pressure sensor) 12 distributed on the surface of the base body 11, and a plurality of plates 13 installed to cover the entire surface of the base body 11 with the depressurization sensors 12 respectively interposed therebetween.

Examples of any stereoscopic shape of the base body 11 include a spherical shape, a polyhedron shape, a circular cylindrical shape (cylindrical shape), a conical shape, an oval sphere shape, and a semi-regular polyhedral shape. In this embodiment, the base body 11 with the spherical shape is used. A part or the entirety of the surface of the base body 11 is partitioned into a plurality of regions. The number of partitions may be two or more. In this embodiment, the entire surface of the spherical shape is partitioned. The sizes of the partitioned regions may not be the same as each other. In this embodiment, however, the sizes of the partitioned regions are the same as each other. The three or more depressurization sensors 12 are disposed at each region. The depressurization sensor 12 is disposed at the vertex position of a polygon with three or more angles. FIG. 15 shows one region of the base body 11. In this embodiment, the three depressurization sensors 12 are disposed at each region. The plurality of plates 13 is disposed so as to cover the entire surface of the base body 11 with each depressurization sensor 12 interposed therebetween in one pair of individual regions of the base body 11. When the base body 11 has a spherical shape, the plate 13 installed to correspond to two regions has a parabola shape. In particular, when the mounting surface of the base body 11 is a spherical surface or a conical surface, the depressurization sensor 12 has a film shape or a thin plate shape so as to be easily mounted after the fashion of the mounting surface.

The material, the thickness, and the like of the plate 13 are appropriately selected so that the plate 13 has rigidity lest the rear surface of the plate 13 comes into contact with the surface of the base body 11 due to curving of the plate 13 and a force transmitted to the depressurization sensor 12 is reduced.

The base body 11 has a hollow portion 14 therein. In the hollow section 14, a substrate 16 is installed which is mounted with electronic components including a controller 15 (mainly, the above-described CPU) executing a predetermined calculation process based on an output of each depressurization sensor 12. More specifically, the controller 15 can execute a calculation process of calculating the position (pressurization position) and a pressure force with which a contacting object such as a finger of a user comes into contact on the plate 13 corresponding to the regions based on detection information of the three or more depressurization sensors 12 installed in each region. A method of detecting the pressurization position and the pressurization force will be described below.

Next, the method of detecting the pressurization position and the pressurization force on the plate 13 corresponding to the region based on the output of the three or more depressurization sensors 12 installed in each region will be described.

To facilitate the description, the plate 13 has not a parabola shape but a flat plate shape.

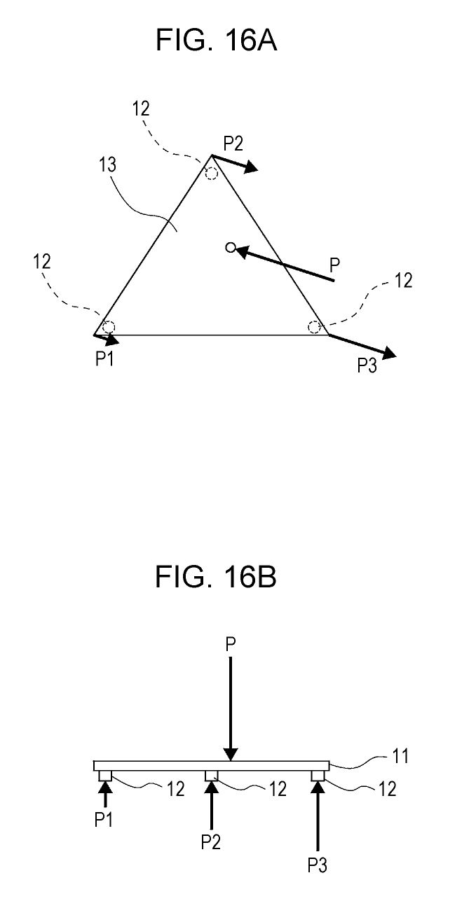

FIGS. 16A and 16B are a plan view and a side view of a detection principle.

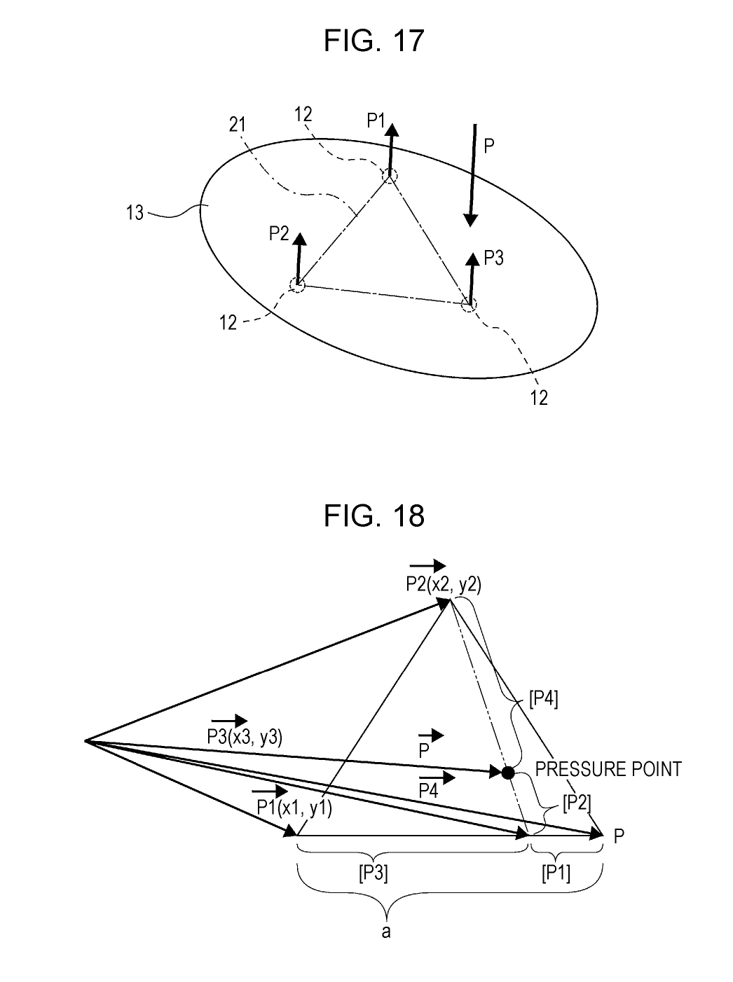

The three depressurization sensors 12 capable of detecting a pressure applied to the plate 13 as a partial pressure are installed to correspond to the positions of the three angle portions of the plate 13 with a triangular plate shape. Here, it is assumed that force P is applied to any pressurization position on the plate 13. The pressurization force P is dispersed in the plate 13 and is distributed to the three depressurization sensors 12 disposed to correspond to the three angle portions of the plate 13. That is, on the assumption that the forces applied to the three depressurization sensors 12 are P1, P2, and P3, a relation expression of P=P1+P2+P3 is satisfied. That is, even when the force P is applied to any position of the plate 13, the force P can be detected as a sum of the output values P1, P2, and P3 of the three depressurization sensors 12. When the depressurization sensors 12 corresponding to positive and negative pressures are used, for example, as shown in FIG. 17, the force P applied to the plate 13 can be calculated by the same method even when the pressurization positions are deviated from a region 21 of a triangle in which the vertexes are three sensor positions. Further, P2 is a negative output among the outputs of the depressurization sensors 12 in FIG. 17.

Next, a method of calculating the pressurization positions will be described with reference to FIG. 18.

Since the positions of the depressurization sensors 12 are known, position vectors P1, P2, and P3 can be drawn, as shown in FIG. 18. Here, a position vector P4 of the point partitioning the side a of the triangle at a ratio of outputs [P3]:[P1] of the depressurization sensors 12 can be expressed as follows:

P4=(P1×[P3]+P3×[P1])/[P1]+[P3] (1)

[P4]=[P1]+[P3].

Here, the pressurization position P is present on a line connecting the point P4 and the point P2 and is a point obtained by partitioning this line at a ratio between [P4] calculated by the expression above and the sensor output [P2], that is, a ratio of [P4]:[P2]. Like the expression above, the position vector P of the pressurization position is expressed as follows:

P=(P2×[P4]+P4×[P2])/[P2]+[P4] (2)

[P]=[P2]+[P4]=[P1]+[P2]+[P3].

That is, the force applied to the pressurization position and the position thereof can be accurately calculated by the output values from the three depressurization sensors 12.

Here, three which is the number of depressurization sensors 12 is the minimum necessary number for calculating the position and the size of the force applied to one plane. Even when the number is increased to four, the same calculation method can be used.

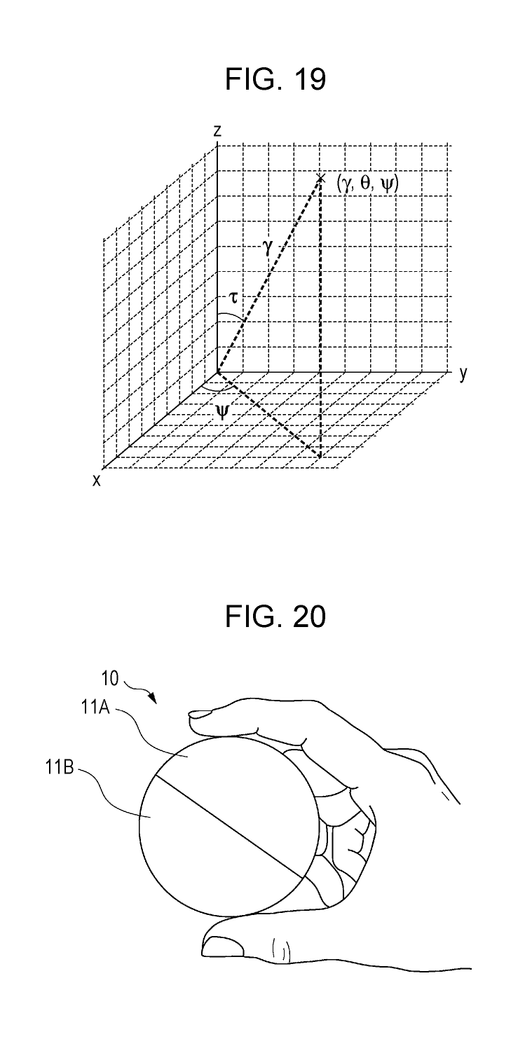

The above-described principle can be applied to the surface of an object with a stereoscopic shape such as a spherical shape. As in this embodiment, when the plate 13 has a spherical surface shape, polar coordinates shown in FIG. 19 can be used in the vector calculation.

When the vector expression (2) above is described as polar coordinates, the following expressions are obtained:

P=(([P3]×ψ1+[P1]×ψ3)/([P1]+[P3], ([P3]×τ1+[P1]×τ3)([P1]+[P3], r) (3)

[P]=[P2]+[P4]=[P1]+[P2]+[P3]

P=(([P4]×ψ2+[P2]×ψ4)/([P2]+[P4], and ([P4]×τ2+[P2]τ4)/([P2]+[P4], r) (4)

[P]=[P2]+[P4]=[P1]+[P2]+[P3]

where, r=the radius of a ball.

When the surface is partitioned into the plurality of regions and is approximated as the coordinate expression of plane coordinates, the polar coordinates, cylindrical coordinates, or the like so as to correspond to the surface shape in each region by using the method, even on the surface of an object with any surface shape such as a spherical surface or a cylindrical surface, the pressurization positions and the pressurization force to the entire object surface with any shape can be calculated.

However, the surface with any shape has to be partitioned by the number of coordinate systems necessary to approximate the shape in the entire surface.

In the operation device 10 according to this embodiment, the controller 15 can individually detect the pressurization position and the pressurization force corresponding to each of the plurality of fingers of a user for each region, when the user grasps two regions 11A and 11B of the base body 11 so that the pressures from his or her fingers are individually applied to the regions 11A and 11B, as shown in FIG. 20.

### Other Embodiments

Embodiments of the disclosure are not limited to the above-described embodiments, but may be realized in various other forms.

In the above-described embodiments, the operation device 10 transmits the information detected by the respective detection functions 22, 23, and 25 to 27 to the display device 50. However, the operation device may perform a plurality of steps among the processes shown in FIG. 6 (the same applies to FIGS. 7 to 12) based on the information detected by the respective detection functions 22, 23, and 25 to 27 and may transmit information obtained through the steps to the display device 50.

For example, the operation device 10 may generate the object information and may transmit the generated object information to the display device 50. In this case, the display device 50 displays the object 51 on the screen based on the received object information. In this case, the operation device 10 may include the object information management function 63 functioning as a generation unit and the like (see FIG. 5).

The operation device 10 may be connected to the display device by a wired method instead of a wireless method.

The shape of the operation device 10 is not limited to the spherical shape, but the operation device 10 may have a shape determined actually by a method of grasping the operation device 10 by the user. For example, the shape of the operation device 10 may be a lever long in one direction and a handle shape gripped by a driver of an automobile.

It is possible to realize an information processing apparatus in which the operation device 10 and the display device 50 are integrated with each other. For example, the information processing apparatus is a portable electronic apparatus including a display which displays an object. Examples of the portable electronic apparatus include a portable telephone and a portable PC.

The present disclosure contains subject matter related to that disclosed in Japanese Priority Patent Application JP 2010-271279 filed in the Japan Patent Office on Dec. 6, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

1. An information processing apparatus comprising:
a generation unit configured to generate object information comprising information for displaying an object to rotate at a velocity corresponding to a rotation velocity, which is detected by a rotation sensor installed in an operation device operated by a user, within a screen based at least in part on the rotation velocity; and
a changing unit configured to change the object information generated by the generation unit based at least in part on a pressure detected by a pressure sensor installed in the operation device.

2. The information processing apparatus according to claim 1, wherein the changing unit changes is configured to change the object information to make the rotation velocity of the object small when the detected pressure becomes large.

3. The information processing apparatus according to claim 1, further comprising:
a retention unit configured to retain a maximum value of the rotation velocity detected within a predetermined period after the rotation sensor detects the rotation velocity,
wherein the generation unit is configured to generate the object information to maintain rotation of the object at a rotation velocity corresponding to the retained maximum value.

4. The information processing apparatus according to claim 1, wherein the changing unit is configured to change the object information to start rotation of the object when the detected pressure is greater than or equal to a threshold value, and to change the object information to stop the rotation of the object when the detected pressure is less than the threshold value.

5. The information processing apparatus according to claim 1, further comprising:
a unit configured to calculate a rotation direction of the operation device,
wherein the generation unit is configured to generate the object information to rotate the object in a direction corresponding to the calculated rotation direction.

6. The information processing apparatus according to claim 1,
wherein the generation unit is configured to generate the object information including information in accordance with a movement velocity, which is obtained based at least in part on an acceleration detected by an acceleration sensor installed in the operation device, so that the object is moved at a velocity corresponding to the movement velocity on the screen based at least in part on the movement velocity, and
wherein the changing unit is configured to change the object information generated by the generation unit so that the movement velocity of the displayed object is changed based at least in part on the pressure detected by the pressure sensor.

7. The information processing apparatus according to claim 6, wherein the changing unit changes is configured to change the object information so that the movement of the object stops when the detected pressure is less than a threshold value.

8. The information processing apparatus according to claim 6, further comprising:
a unit configured to calculate a movement direction which, is a direction of the operation device at a movement velocity,
wherein the generation unit is configured to generate the object information so that the object is moved in the calculated movement direction.

9. The information processing apparatus according to claim 8, wherein the changing unit is configured to change the object information so that the movement direction of the object is changed in accordance with the detected rotation velocity.

10. The information processing apparatus according to claim 1, wherein the changing unit is configured to change the object information so that a size, a movement distance, or a color of the object is changed in accordance with the detected pressure.

11. The information processing apparatus according to claim 1, wherein the operation device includes
a base body,
three or more pressure sensors set at each of a plurality of regions partitioned from at least a part region of a surface of the base body and are installed at different vertex positions of a polygon having three or more angles, and
a plurality of plates disposed so as to cover the surface of the base body with the three or more pressure sensors interposed therebetween to correspond to each region of the base body.

12. An information processing system comprising:
an operation device which includes a rotation sensor, a pressure sensor, and a transmission unit configured to transmit information regarding a rotation velocity detected by the rotation sensor and information regarding a pressure detected by the pressure sensor and which is operated by a user;
a reception unit configured to receive the information regarding the rotation velocity and the information regarding the pressure; and
a display control apparatus which includes:
a generation unit configured to generate object information comprising information for displaying an object to rotate at a velocity corresponding to the received rotation velocity within a screen,. and
a changing unit configured to change the object information generated by the generation unit based at least in part on the received information regarding the pressure.

13. An information processing method comprising:
generating object information comprising information for displaying an object to rotate at a velocity corresponding to a rotation velocity, which is detected by a rotation sensor installed in an operation device operated by a user, within a screen based at least in part on the rotation velocity; and
changing the generated object information based at least in part on a pressure detected by a pressure sensor installed in the operation device.

14. An information processing apparatus comprising:
a generation unit configured to generate object information including information for displaying an object to move at a velocity corresponding to a movement velocity, which is obtained based at least in part on an acceleration detected by an acceleration sensor installed in an operation device operated by a user, within a screen based at least in part on the movement velocity; and
a changing unit configured to change the object information to change a direction of the movement velocity based at least in part on a rotation velocity detected by a rotation sensor installed in the operation device.

15. An information processing apparatus comprising:
an acquisition unit configured to acquire pressure information from a pressure sensor installed in an operation device operated by a user; and
a user operation detection unit configured to determine start and end of an operation by a toggle process to determine, the start of the operation, and the operation of the user when a pressure equal to or greater than or equal to a threshold value is acquired within a predetermined period from a time of acquiring a pressure less than the threshold value and the pressure less than the threshold value is again acquired.

16. An information processing apparatus comprising:
an acquisition configured to acquire pressure information from a pressure sensor installed in an operation device operated by a user; and
a user operation detection unit configured to start reception of the operation of the user from a time when the pressure sensor acquires a pressure greater than or equal to a threshold value and which ends the reception of the operation of the user when a pressure less than the threshold value is detected.
